(19) United States
(12) Patent Application Publication
(10) Pub. No.: US 2026/0356612 A1
(43) Pub. Date: Nov. 12, 2026

(54) Suction box for a sheet transport system

(71) Applicant: CANON KABUSHIKI KAISHA, Tokyo (JP)

(72) Inventors: Ern J.J. CLEVERS, Broekhuizenvorst (NL); Martinus H. CARIS, Weert (NL)

(21) Appl. No.: 19/673,897

(22) Filed: May 11, 2026

(30) Foreign Application Priority Data
May 12, 2025 (EP) 25175822.3

(51) Int. Cl. B65H 5/22

(52) U.S. Cl. CPC B65H 5/224

(57) ABSTRACT

A suction box for a sheet transport system. The suction box forms an air duct from a sheet transport side to a vacuum source side. The suction box includes: a valve flap rotatable about a rotation axis, arranged in the air duct and configured for controlling an air flow through the air duct; a first bypass opening in a side wall of the air duct, wherein the rotation axis of the valve flap is perpendicular to the side wall; and a first closing plate arranged perpendicular to the valve flap and rotatable together with the valve flap and configured for covering the first bypass opening in an opened state of the valve flap and uncovering the first bypass opening in a closed state of the valve flap.

### CROSS-REFERENCE TO RELATED APPLICATIONS

This application claims priority to European Patent Application No. 25175822.3 filed on May 12, 2025, which is incorporated by reference herein in its entirety.

### BACKGROUND OF THE DISCLOSURE

### 1. Field of the Disclosure

The present disclosure relates to a suction box for a sheet transport system, the suction box forming an air duct from a sheet transport side of the suction box to a vacuum source side of the suction box.

### 2. Description of Background Art

Sheet transport systems are used, for example, in printers in order to convey media sheets through various processing stages of the printers. Frequently, it is desired to attract media sheets to a perforated conveyer belt that defines a sheet transport path and runs over at least one suction box, which creates a high suction pressure (or vacuum pressure) so that the sheets are safely held in position without touching an upper side of the sheets, for example during printing on the upper side of the sheets or while ink is still wet on the sheets. In some cases, fast switching of vacuum segments is desired. Vacuum setpoints may vary over time between zero Pascals and several hundreds of Pascals. Reaching zero vacuum pressure requires an almost “airtight” valve for closing off a vacuum segment.

### SUMMARY OF THE DISCLOSURE

The present disclosure provides a suction box that allows for fast switching of suction pressure. It is desirable that the suction box has a valve that allows for both fast switching and high suction pressures. It is desirable that the suction box allows for reaching zero suction pressure, for example, by providing an air-tight valve.

According to an aspect of the present disclosure, in order to achieve one or more of these objectives, there is provided a suction box for a sheet transport system, the suction box forming an air duct from a sheet transport side of the suction box to a vacuum source side of the suction box, wherein the suction box comprises: a valve flap rotatable about a rotation axis and configured for controlling an air flow through the air duct, wherein the valve flap is arranged in the air duct; a first bypass opening in a side wall of the air duct, wherein the rotation axis of the valve flap is perpendicular to the side wall; and a first closing plate arranged perpendicular to the valve flap and rotatable together with the valve flap and configured for covering the first bypass opening in an opened state of the valve flap and uncovering the first bypass opening in a closed state of the valve flap.

Thereby, when the valve flap is closed, the first bypass opening is uncovered, so that a suction pressure may quickly be lowered by introducing ambient air into the air duct through the first bypass opening. For example, a higher vacuum pressure may be quickly replaced by a lower vacuum pressure or ambient pressure. The valve flap furthermore allows for a fast switching time between the opened state and the closed state of the valve flap. By closing the valve flap, a connection to the respective vacuum source (e.g. a pump or fan) is sealed off, which allows the vacuum source to keep running while reducing the vacuum pressure on the opposite side of the valve flap. Generally, a valve flap can be actuated rapidly as compared to adjustments made by e.g. starting up or shutting down the vacuum source. Moreover, when the first bypass opening is open and the valve flap is closed, it is made possible to reduce the suction pressure at the sheet transport side to zero, due to the connection of at least a part of the air duct to the ambient atmosphere, while the vacuum source may still operate. In particular, the suction pressure at the sheet transport side may be reduced to zero (0 Pa) even in case of a small leakage flow of the valve flap. On the other hand, in the opened state of the valve flap, the first bypass opening may be closed. Thus, a maximum negative pressure may be applied through the suction box.

Thereby, the objective of the present disclosure has been achieved.

More specific optional features are indicated in the dependent claims.

The first bypass opening may be arranged above the valve flap in a closed state of the valve flap, or the first bypass opening may be arranged below the valve flap in a closed state of the valve flap. The first bypass opening may be arranged across the valve flap in a closed state of the valve flap. Preferably, the first bypass opening is positioned on a side of the valve flap in its closed state, which side extends towards the suction box. The vacuum source is therein on the opposite side of the valve flap.

According to another aspect of the present disclosure, there is provided a suction box for a sheet transport system, the suction box forming an air duct from a sheet transport side of the suction box to a vacuum source side of the suction box, wherein the suction box comprises: a valve flap rotatable about a rotation axis and configured for opening and closing the air duct, wherein the valve flap is arranged in the air duct; a first bypass opening in a side wall of the air duct, the first bypass opening arranged above the valve flap in a closed state of the valve flap; a second bypass opening in a side wall of the air duct, the second bypass opening arranged below the valve flap in the closed state of the valve flap; and first and second closing plates arranged perpendicular to the valve flap and rotatable together with the valve flap and configured for respectively covering the first and second bypass openings in an opened state of the valve flap and uncovering the first and second bypass openings in the closed state of the valve flap. It will be appreciated that above and below herein are defined with respect to the direction of flow through the air duct. The vertical direction from above to below therein is opposite the net air flow direction through the air duct at the valve flap.

Thus, in the opened state of the valve flap, the first and second bypass openings may be closed by the respective first and second closing plates covering the bypass openings. Thus, when the valve flap is fully open, a maximum negative pressure may be applied through the suction box.

Conversely, in the closed state (or fully closed state) of the valve flap, the uncovered first bypass opening above the valve flap (to the sheet transport side) ensures that a vacuum pressure close to zero (such as a lower negative pressure or ambient pressure) can be reached even if there is a small leakage of the valve flap. Moreover, in the closed state of the valve flap, the uncovered second bypass opening below the valve flap (to the vacuum source side) ensures that there is sufficient flow to the vacuum source to cool the vacuum source, such as a fan, and prevent overheating of the vacuum source. Thus, when closing the valve flap completely reduces the airflow to zero, a risk for overheating the fan that creates the vacuum is avoided.

In the above-described aspects, the valve flap may form a butterfly valve. The butterfly valve may also be termed a swing valve. Generally, a swing valve may have a highly nonlinear relation between the flow resistance and the valve angle. The first closing plate and the first bypass opening may form a first bypass valve. The second closing plate and the second bypass opening may form a second bypass valve. By the combination of the butterfly valve and the bypass valve / the bypass valves, the overall pressure versus valve angle relation may be linearized to a major extent. For example, the effective open area per rotation angle of the butterfly valve may be roughly opposite to that of the bypass openings/closing plates. This may result in a net relation of the air resistance versus angle that is roughly linear. This is advantageous for a valve drive system of a suction box. Preferably, the first and/or second bypass opening extend over a majority of the path of the valve flap between the open and closed state.

One or more of the above-described aspects may include one or more of the following features and of the features indicated in the dependent claims.

The mentioned opened state of the valve flap may be a fully opened state of the valve flap.

The respective closing plate may be configured for increasing the covered area of the respective bypass opening with an increasing opening angle of the valve flap. That is, the covered area of the respective bypass opening increases with the opening angle of the valve flap. The respective closing plate may be configured for starting to increase the covered area of the respective bypass opening when (or immediately when) the valve flap is moved from its closed state (leaves its closed state).

The second bypass opening may be in the same side wall as the first bypass opening or in an opposite side wall.

The sheet transport side may be the top side of the suction box. The vacuum source side may be the bottom side of the suction box.

The suction box may comprise a housing that forms the air duct. The respective side wall having the first or second bypass opening may be a side wall of the housing.

The air duct may have a rectangular cross-section. The suction box may have an open end at the sheet transport side. The suction box may have a top wall with openings at the sheet transport side.

The valve flap may comprise two wings on opposite sides of the rotational axis. The valve flap may be rectangular or, in particular, substantially square. The valve flap may form a butterfly valve, in particular a rectangular butterfly valve. The butterfly valve may also be termed a swing valve. The valve flap may also be termed a valve closure member.

The valve flap may be configured to be rotatable by one quarter-turn between its fully opened state and the closed state. For example, the valve flap may be configured to be rotatable by approximately 90° (for example, at least 80°, more preferably at least 85°).

In a fully opened state of the valve flap, the valve flap may be arranged vertically and/or substantially parallel to cross side walls of the air duct, the cross side walls being parallel to the rotation axis of the valve flap and/or connecting the side wall that has the first bypass opening to an opposite side wall of the suction box. In the closed state of the valve flap, the valve flap may extend across the air duct and/or may be arranged substantially horizontally and/or substantially perpendicular to the cross side walls or all side walls of the air duct.

The closing plate may be termed a bypass closing plate. The closing plate may be a flange member. The first closing plate and the first bypass opening may form a first bypass valve. Thus, the suction box combines a butterfly valve or swing valve with a bypass valve, or with two bypass valves. The first bypass valve may be connected to the air duct above the butterfly valve. The first bypass valve may be configured for venting a sheet transport side part of the air duct, that is, for connecting the sheet transport side of the air duct to the environment. Thereby, a vacuum at the sheet transport side of the suction box may be quickly vented.

The second closing plate and the second bypass opening may form a second bypass valve. The second bypass valve may be connected to the air duct below the butterfly valve. The second bypass valve may be configured for connecting a vacuum source side of the air duct to the environment. Thereby, air may be introduced to the vacuum source side of the suction box. Thereby, it is ensured that there is sufficient flow to the vacuum source to prevent overheating of the vacuum source.

The respective bypass opening may form a bypass in the housing of the air duct. The bypass may be configured to bypass the closed valve flap. The bypass openings may be arranged respectively above and below the rotation axis of the valve flap.

The rotation axis of the valve flap may be perpendicular to the side wall having the second bypass opening.

In embodiments, the first and second bypass openings are arranged in the same side wall of the air duct.

The respective bypass opening may be sector-shaped, extending in the circumferential direction around the rotation axis of the valve flap. Thus, a large bypass opening is made possible that may be effectively closed by rotation of the respective closing plate. The respective bypass opening may have the shape of a circular sector extending in the circumferential direction around the rotation axis of the valve flap. That is, the sector-shaped bypass opening may exclude an area surrounding the rotation axis, for example, an area surrounding and including a mounting shaft of the valve flap.

The respective bypass opening may have an angular range of extension in the circumferential direction around the rotation axis of the valve flap, which angular range corresponds to an angular difference (a rotation angle) between the fully opened state and the closed state of the valve flap. Thus, interaction of the bypass opening and the valve flap may be improved. The respective bypass opening may have an extension of 90° or less, in particular, an extension of about 90°, in the circumferential direction around the rotation axis of the valve flap. The respective closing plate may have an extension of at least 90°, in particular, an extension of about 90°, in the circumferential direction around the rotation axis of the valve flap.

The respective bypass opening may have an angular range of extension in the circumferential direction around the rotation axis of the valve flap, which angular range corresponds to a quarter circle. For example, the angular range of extension may be approximately 90° (for example, at least 80°, more preferably at least 85°). Thereby, the effect of the bypass opening may be maximized.

The respective bypass opening may have a maximum radial extension of at least two thirds of the maximum radial extension of the valve flap, with respect to the rotation axis. A large bypass opening has been found to improve the relation between the flow resistance and the valve angle of the valve flap.

The respective closing plate may be disposed on the outside of the air duct. This is advantageous for streamlining the air duct. The respective closing plate may be disposed on the outside of the suction box, in particular, on the outside of the housing of the suction box.

The respective closing plate and/or the closing member may be mounted to a shaft (such as a rotation axle, or a shaft member) of the valve flap, so that it moves with the rotation of the valve flap.

The suction box may comprise a valve seat for the valve flap. The valve seat may include a seal. The air duct may comprise protrusions forming the valve seat for the valve flap. The valve flap may contact these valve seat protrusions in the closed state of the valve flap. The valve seat protrusions may be arranged on opposite sides of the rotation axis of the valve flap. The valve seat protrusions may comprise lower protrusions forming a lower valve seat part for being contacted by one wing of two wings of the valve flap and upper protrusions forming an upper valve seat part for being contacted by the other one of the two wings of the valve flap.

The suction box may be connected to a vacuum source. The suction box may be directly connected to the vacuum source. The vacuum source may be arranged at the bottom side of the suction box. The vacuum source may comprise at least one of a fan or a pump.

The suction box may comprise a drive for the valve flap and the closing plate or closing plates, such as a motor. The drive may be arranged on a side wall opposite to a side wall having the first bypass opening or the bypass openings.

The suction box may comprise a sensor for sensing a position of the first (or second) closing plate or the closing member or a rotational position of the valve flap. Thus, opening or closing of the valve flap and closing plate may be reliably effected.

The suction box may comprise a controller operably connected to the drive and configured to control the drive based on an output of the sensor.

In embodiments, first bypass openings may be arranged in side walls on opposite sides of the air duct, with respective first closing plates. In embodiments, second bypass openings may be arranged in side walls on opposite sides of the air duct, with respective second closing plates. Thus, the effect of the bypass opening may be doubled.

In a further aspect, there is provided a sheet transport system that comprises at least one perforated belt that defines a sheet transport path and runs over at least one suction box as described herein.

### BRIEF DESCRIPTION OF THE DRAWINGS

The present disclosure will become more fully understood from the detailed description given herein below and the accompanying drawings which are given by way of illustration only, and thus are not limitative of the present disclosure, and wherein:

FIG. 1 is a schematic side view of a sheet transport system according to an embodiment, showing a suction box in a suctioning state;

FIG. 2 is a schematic side view of the sheet transport system of FIG. 1 in a non-suctioning state of the suction box;

FIG. 3 is a schematic perspective view of a suction box according to another embodiment in a suctioning state;

FIG. 4 is a schematic side view of the suction box of FIG. 3 in a non-suctioning state; and

FIG. 5 is a schematic cross-sectional view of another embodiment of a suction box as in FIG. 2.

### DETAILED DESCRIPTION OF THE EMBODIMENTS

The present disclosure will now be described with reference to the accompanying drawings, wherein the same reference numerals have been used to identify the same or similar elements throughout the several views.

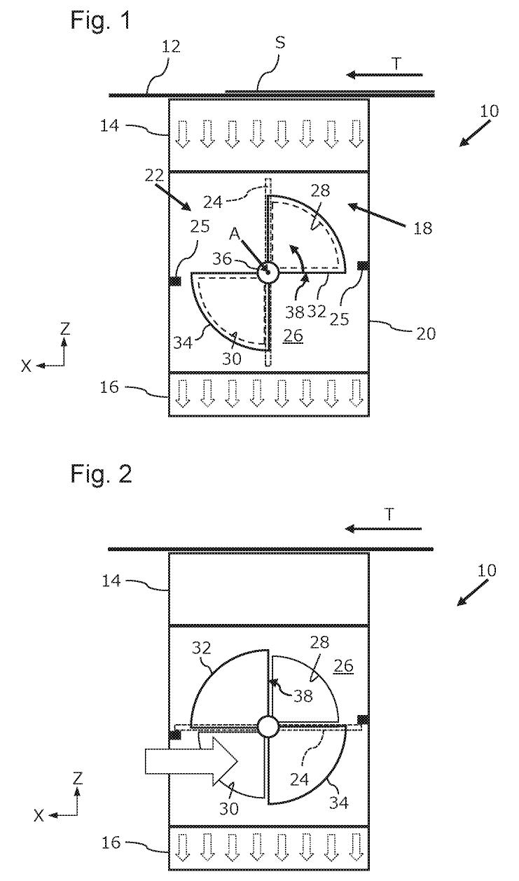

As shown in FIG. 1, a sheet transport system includes a suction box 10 and a perforated belt 12 that defines a sheet transport path in sheet transport direction T and runs over a top vacuum segment 14 of the suction box 10. The suction box 10 furthermore includes a vacuum source 16 in the form of a fan, configured for drawing air from the suction box 10. The vacuum source 16 is arranged at the bottom of the suction box 10. The vertical direction is the Z direction.

The suction box 10 forms an air duct 18 that extends from the top side of the vacuum segment 14 to the bottom side of the suction box 10. The air duct 18 has a rectangular cross-section in the main part of the suction box 10 and in the vacuum segment 14. A housing 20 of the suction box 10 defines the air duct 18.

The suction box 10 includes a butterfly valve 22 having a valve flap 24 rotatable about a rotation axis A and a valve seat 25 protruding from the side walls of the suction box 10. In FIG. 1, the butterfly valve 22 is fully opened, that is, the valve flap 24 is in its fully opened state. The rotation axis is parallel to the Y direction.

As shown in FIG. 1, a side wall 26 of the suction box 10 has first and second bypass openings 28, 30 arranged respectively above and below the rotation axis A. In the state in FIG. 1, first and second closing plates 32, 34 cover the bypass openings 28, 30.

The vacuum source 16 generates a vacuum inside the suction box 10. The vacuum segment 14 has a top wall with openings, which supports the belt 12. In FIG. 1, dotted arrows indicate the air flow in the air duct 18, by which a suction pressure is generated that holds a sheet S to the moving belt 12.

The first and second closing plates 32, 34 are mounted to a shaft 36 of the valve flap 24 and are rotatable together with the valve flap 24. The bypass openings 28, 30 and closing plates 32, 34 form bypass valves.

In the situation of FIG. 1, the butterfly valve 22 is open, while the upper and lower bypass valves are closed.

FIG. 2 shows a closed state of the butterfly valve 22, in which the valve flap 24 contacts the valve seat 25. Thus, the butterfly valve 22 is sealed, while the bypass openings 28, 30 are uncovered. Therefore, ambient air is drawn in through the second bypass opening 30. At the same time, the first bypass opening 28 connects the top side of the suction box 10 to the environment, so that the suction pressure at the vacuum segment 14 becomes zero.

A trailing edge 38 of the first closing plate 32, when the first closing plate 32 is moved from its closed position (FIG. 1) into its opening position (FIG. 2), has an angular offset of 90° (in the X, Z plane) with respect to the plane of the valve flap 24. In FIG. 1, this trailing edge 38 is horizontal and extends parallel to the X direction. In FIG. 2, this trailing edge 38 is vertical. Likewise, a trailing edge of the second closing plate 34, when the second closing plate 34 is moved from its closed position (FIG. 1) into its opening position (FIG. 2), has an angular offset of 90° with respect to the plane of the valve flap 24. Correspondingly, the first and second bypass openings 28, 30 are arranged in respective diagonally opposite quadrants of the side wall 26 above or, respectively, below the rotation axis A. At the respective trailing edge 38, the respective bypass opening 28, 30 starts to open with the beginning of the closing movement of the butterfly valve 22.

In the situation of FIG. 2, the butterfly valve 22 is closed, while the upper and lower bypass valves are open. Therefore, while the vacuum source 16 continues to operate, the suction pressure at the sheet transport side of the suction box 10 is reduced to zero pressure. Thus, the suction box 10 is switched from the suctioning state or vacuum state of FIG. 1 to a zero-vacuum state, by rotating the valve flap 24 and the first and second closing plates 32, 34 counter-clockwise by 90° (when seen as in FIGS. 1 and 2).

The sheet transport system may include a plurality of suction boxes 10 arranged in a row along the sheet transport direction T, which may be switched independently of each other.

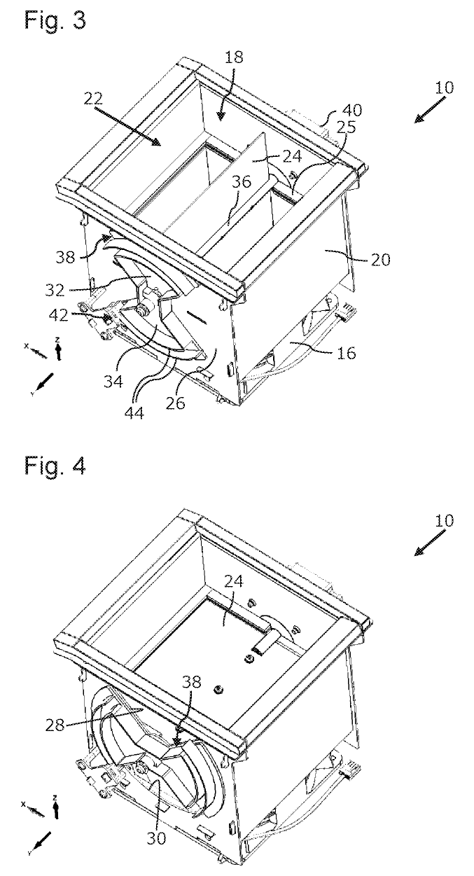

FIGS. 3 and 4 show another embodiment of a suction box 10. The vacuum segment 14 is not shown in FIGS. 3 and 4. The suction box 10 is similar to the suction box 10 of FIGS. 1 and 2, and similar components are indicated with the same reference signs. The differences to the suction box 10 of FIGS. 1 and 2 are described in the following.

In the embodiment of FIGS. 3 and 4, the trailing edge 38 of the first closing plate 32, when the first closing plate 32 is moved (clockwise in FIGS. 3 and 4) from its closed position (FIG. 3) into its opening position (FIG. 4), has an angular offset of 45° (in the X, Z plane) with respect to the plane of the valve flap 24. Correspondingly, the first and second bypass openings 28, 30 are arranged centrally above or, respectively, below the rotation axis A. Thereby, in the opened state of the butterfly valve 22, the bypass openings 28, 30 have a high efficiency. At the respective trailing edge 38, the respective bypass opening 28, 30 starts to open with the beginning of the closing movement of the butterfly valve 22.

FIGS. 3 and 4 furthermore show a driving motor 40 of the butterfly valve 22 and a sensor 42 for sensing a position of a closing member forming the first and second closing plates 32, 34. The vacuum source 16 is also shown at the bottom of the suction box 10.

As shown in FIGS. 3 and 4, the closing member and the first and second closing plates 32, 34 each include reinforcement ribs 44 at the outer side thereof.

In the situation of FIG. 3, the butterfly valve 22 is open, while the upper and lower bypass valves are closed. Thus, the suction box 10 is in its suctioning state or vacuum state. In the situation of FIG. 4, the butterfly valve 22 is closed, while the upper and lower bypass valves are open. Therefore, while the vacuum source 16 continues to operate, the suction pressure at the sheet transport side of the suction box 10 is reduced to zero pressure. Thus, the suction box 10 is switched from the suctioning state or vacuum state of FIG. 3 to a zero-vacuum state.

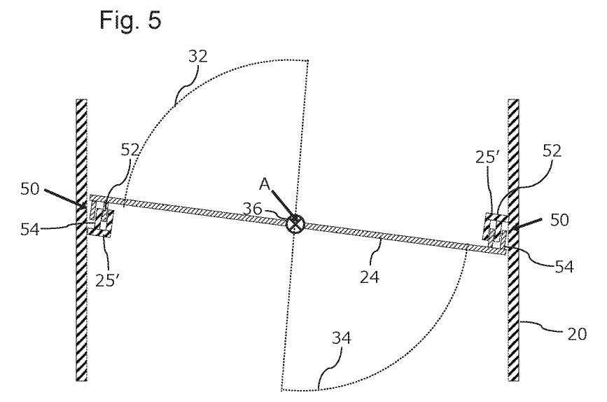

FIG. 5 illustrates a cross-sectional view to illustrate the sealing at the valve seat 25’. In FIGS. 1-4, the valve seat 25 is formed as a stop surface, which is in contact with the valve flap 24 around the periphery thereof. By being positioned against one another, a substantially air tight seal may be achieved. This manner of sealing requires accurately positioning the valve flap 24 against the sealing surface of the valve seat 25 and/or a constant urging force to keep the two pressed together. This may be achieved by a suitable motor for controlling the valve flap in combination with a suitable controller. FIG. 5 illustrates an embodiment, wherein the positional requirements for valve flap positioning may be reduced. In FIG. 5, a labyrinth seal 50 is formed by the ends of the valve flap 24 and the valve seat 25’ when the valve flap 24 is in the closed position, as in FIG. 2. The labyrinth seal 50 is a mechanical seal that provides a tortuous path with relatively high air passage to minimize air or any other gas leaking away through this path. In FIG. 5, the labyrinth seal 50 is formed as a meandering passage. The passage is created by one or more protrusions 52, 54 being positioned inside a correspondingly shaped and positioned recess, preferably in a contactless manner. In FIG. 5, multiple protrusions 52, 54 are provided on both the valve flap 25 and the valve seat 35’. The protrusions 52 on the valve flap 24 are offset with respect to the protrusions 54 on the valve seat 25’, so that each valve flap protrusion 52 is received between two valve seat protrusions 54. It will be appreciated that any number of protrusions 52, 54 may be applied, and that a single recess in combination with a single to be received protrusion may be sufficient to form a labyrinth seal. The recess may be on the valve flap 24 and the protrusion on the valve seat 25’, or vice versa, or even a combination of these two situations. Any other form of a labyrinth seal may be applied as well.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms "comprise", "comprising", "include", "including", "contain", "containing", "have", "having", and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms "a" and "an" used herein are intended to be understood as meaning one or more unless explicitly stated otherwise. Moreover, the terms "first", "second", "third", etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A suction box for a sheet transport system, the suction box forming an air duct from a sheet transport side of the suction box to a vacuum source side of the suction box, wherein the suction box comprises:
a valve flap rotatable about a rotation axis and configured to control an air flow through the air duct, wherein the valve flap is arranged in the air duct;
a first bypass opening in a side wall of the air duct, wherein the rotation axis of the valve flap is perpendicular to the side wall; and
a first closing plate arranged perpendicular to the valve flap and rotatable together with the valve flap, the first closing plate being configured to cover the first bypass opening in an opened state of the valve flap and uncovering the first bypass opening in a closed state of the valve flap.

2. The suction box according to claim 1, wherein the first bypass opening is arranged above the valve flap in the closed state of the valve flap, wherein the suction box further comprises:
a second bypass opening in the side wall of the air duct, the second bypass opening arranged below the valve flap in the closed state of the valve flap; and
a second closing plate arranged perpendicular to the valve flap and rotatable together with the valve flap, the second closing plate being configured to cover the second bypass opening in the opened state of the valve flap and uncovering the second bypass opening in the closed state of the valve flap.

3. The suction box according to claim 2, further comprising a closing member that forms the first and second closing plates.

4. The suction box according to claim 2, wherein the first and second bypass openings are sector-shaped, extending in a circumferential direction around the rotation axis of the valve flap.

5. The suction box according to claim 3, wherein the first and second closing plates are disposed on the outside of the air duct.

6. The suction box according to claim 3, wherein the first and second closing plates and/or the closing member is mounted to a shaft of the valve flap.

7. The suction box according to claim 3, wherein the first and second closing plates and/or the closing member comprises reinforcement ribs.

8. The suction box according to claim 1, further comprising a vacuum source arranged at a bottom end of the air duct.

9. A sheet transport system comprising at least one perforated belt that defines a sheet transport path and runs over at least one of the suction box according to claim 1.

10. A sheet printer comprising the sheet transport system according to claim 9.
